(19) United States
(12) Patent Application Publication
(10) Pub. No.: US 2013/0132303 A1
(43) Pub. Date: May 23, 2013

(54) SYSTEM AND PROCESS TO PROVIDE A SECURITY THAT CLOSELY MIRRORS RETURNS OF AN INDIVIDUAL SECURITY WHILE ALSO PROVIDING STOCK LOAN INCOME

(71) Applicant: TFS CAPITAL LLC, West Chester, PA (US)

(72) Inventor: Richard GATES, Chester, PA (US)

(73) Assignee: TFS CAPITAL LLC, West Chester, PA (US)

(21) Appl. No.: 13/680,821

(22) Filed: Nov. 19, 2012

Related U.S. Application Data
(60) Provisional application No. 61/563,231, filed on Nov. 23, 2011.

(51) Int. Cl. G06Q 40/06

(52) U.S. Cl. CPC G06Q 40/06
USPC 705/36 R

(57) ABSTRACT

The invention includes a process and a transaction system that allows, tracks, and monitors at least one of an individual security and a security that closely mirrors returns of the individual security. The system includes a database that stores information related to at least one of the individual security and the security that closely mirrors returns of the individual security associated with a lender, a server configured to receive a request from an investor to borrow at least one of the individual security and the security that closely mirrors returns of the individual security, the server further configured to execute a lending transaction requested by the investor to borrow at least one of the individual security and the security that closely mirrors returns of the individual security, and the server further configured to track and monitor the lending transaction.

### CROSS-REFERENCE TO RELATED APPLICATIONS

This application claims the benefit from U.S. Provisional Application No. 61/563,231 filed on Nov. 23, 2011, which is hereby incorporated by reference in its entirety for all purposes as if fully set forth herein.

### BACKGROUND OF THE DISCLOSURE

1. Field of the Disclosure

This disclosure is directed to a system and process to provide a security that closely mirrors returns of an individual security while also providing stock loan income, and particularly to a system and method to allow, track, and/or monitor the security that closely mirrors returns of an individual security while also providing stock loan income.

2. Related Art

The global security lending industry is economically huge. In markets regulated by the United States alone, there are trillions of dollars' worth of securities (e.g. stocks, REITs, ADRs, etc.) available to be lent each day between lenders and borrowers. According to Data Explorers, approximately $12.4 trillion worth of securities were available to loan globally as of Nov. 23, 2010 which was up from $10.9 trillion a year prior.

Borrowers generally borrow securities so that they can then sell the shares short in the market. In these instances, the initial borrow of shares is required by regulation (e.g., in the United States, see the Securities Exchange Act of 1934 and Regulation SHO.) The borrowing makes the subsequent short sell legitimate.

Lenders are aware of the need and know if a borrower wants a security badly enough, they will be willing to pay the lender to borrow the security. As a result, the lenders sometimes charge fees for the rights to borrow the securities. The methodology for calculating the fees vary from transaction to transaction, but is oftentimes based on the value of the securities lent. For example, if a borrower wants to borrow $1,000,000 of XYZ Corporation stock, the lender may lend the security while assessing a hard to borrow fee of 20% annually. This means that for the right to borrow that stock, the borrower will pay $200,000 to the lender each year.

Each year, there are huge amounts of fees paid between borrowers and lenders. These fees currently exceed billions of dollars. According to SunGard, U.S. equity securities lending volume was $400 billion as of Jul. 11, 2011 with an average borrowing cost of 70 basis points.

Unfortunately, many investors who own securities do not reap the benefits of this security lending market and do not lend out their shares. They may not do so for a number of reasons including, but not limited to, (1) they are unaware the market exists; (2) the custodian or broker who holds the securities does not allow them to lend out the securities; (3) the custodian or broker who holds the securities has a contractual right to lend out the securities and not share the fees with the beneficial owner of the security; and/or (4) it is too onerous to participate in the market.

There are existing products that track the performance and stock lending revenue of indices or baskets of securities. An example of such an existing product is the “Barclays ETF Plus Emerging Market Notes” that has a CUSIP of 06738G886. However, this product mirrors a group or basket of various securities that are being lent and not an individual security.

Accordingly, there is a need for owners of securities to be able to easily participate in the lending market and obtain fees by lending their securities to borrowers.

### SUMMARY OF THE DISCLOSURE

In one aspect of the invention a transaction system that allows, tracks, and monitors at least one of an individual security and a security that closely mirrors returns of the individual security includes a database that stores information related to at least one of the individual security and the security that closely mirrors returns of the individual security associated with a lender, a server configured to receive a request from an investor to borrow at least one of the individual security and the security that closely mirrors returns of the individual security, the server further configured to execute a lending transaction requested by the investor to borrow at least one of the individual security and the security that closely mirrors returns of the individual security, the server further configured to track the lending transaction, and the server further configured to monitor the lending transaction.

In another aspect of the invention a non-transitory computer readable medium when executed on a computer allows, tracks, and monitors at least one of an individual security and a security that closely mirrors returns of the individual security includes instructions for storing information related to at least one of the individual security and the security that closely mirrors returns of the individual security associated with a lender in a database, instructions for receiving a request from an investor to borrow at least one of the individual security and the security that closely mirrors returns of the individual security in a server, instructions for executing a lending transaction requested by the investor to borrow at least one of the individual security and the security that closely mirrors returns of the individual security with the server, instructions for tracking the lending transaction with the server, and instructions for monitoring the lending transaction with the server.

In yet another aspect of the invention a process allows, tracks, and monitors at least one of an individual security and a security that closely mirrors returns of the individual security using a database in a server includes storing information related to at least one of the individual security and the security that closely mirrors returns of the individual security associated with a lender in a database, receiving a request from an investor to borrow at least one of the individual security and the security that closely mirrors returns of the individual security in a server, executing a lending transaction requested by the investor to borrow at least one of the individual security and the security that closely mirrors returns of the individual security with the server, tracking the lending transaction with the server, and monitoring the lending transaction with the server.

In yet another aspect of the invention, the lending income of a Borrowed Security is expected to be a material source of its investment returns.

In yet another aspect of the invention, the Borrowed Security would mirror an individual security that is being lent out in the security lending industry. The Borrowed Security would not mirror a group or basket of various securities that are being lent out in the security lending industry.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1 shows exemplary architecture of a system constructed according to aspects of the invention.

FIG. 2 shows a transaction process according to aspects of the invention.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

The invention is directed to a way for owners of securities to be able to easily participate in the lending market and obtain fees by lending their securities to borrowers. The invention is further directed to a system and process to allow, track, and/or monitor the participation in lending securities to borrowers.

A number of entities borrow securities. It has been recognized that the cost to borrow many of these securities has increased. It is believed that the cost to borrow securities would decrease if there was a greater supply of lenders. It has been further recognized that many investors do not lend out their shares. Accordingly, many investors do not participate and/or benefit from the income that can be produced from the security lending industry.

The invention has value to a company in that it will enable the charging of fees and/or collection of income resulting from the management of many securities.

In addition, the invention is very favorable in that it is one of the few inventions in the financial services industry that would indisputably benefit retail investors. By offering these products, the value of the brand of the provider would increase dramatically. The invention would also provide new business opportunities. Hundreds of securities could be launched that combined could potentially have trillions of dollars' worth of assets. A company would be able to charge fees and/or collect income resulting from the management of these securities.

The process of the invention is based on offering new securities (“Borrowed Securities.”) Each Borrowed Security mimics the performance of an underlying security while also providing the investor a portion of the fees generated from the lending activity. Borrowed Securities could be structured as an exchange traded funds, closed end mutual funds, open ended mutual funds, partnerships, unit investment trust and/or other entities. To accomplish the goal of letting investors derive benefits from lending out securities, each Borrowed Security would directly buy (or indirectly acquire through derivative transactions such as a SWAP or other derivative products) the underlying security that it is designed to mimic. The Borrowed Security would also attempt to directly lend (or indirectly lend through derivative transactions such as a SWAP or other derivative products) out the underlying security to a borrower who would pay a fee. A portion of the fees received from this lending activity could then be passed along to the beneficial owners of the Borrowed Security.

For instance, one Borrowed Security could attempt to closely mirror the performance of common equity in Krispy Kreme Doughnuts Inc. (Ticker in the United States: KKD), while also providing the owner of the Borrowed Security a portion of the fees generated from lending that specific stock to borrowers. So, if Krispy Kreme Doughnuts Inc. stock appreciated by 10% while also generating 5% in fees in the stock loan market, the owner of the corresponding Borrowed Security could generate returns that exceed 10% but are less than 15%.

The firm offering (and/or managing) the Borrowed Securities to investors could generate substantial revenue by charging fees and collecting a portion of the income collected from stock lending industry. There is also a possibility of using the invention in conjunction with single stock futures.

The customer would be able to derive benefits from participating in the global securities lending market more efficiently and effectively. Competitors would benefit from the use of Borrowed Security since it would enable them to manage products in a better way. In addition, the invention provides general credibility and helps build a brands' value and the Borrowed Security would be beneficial to Institutional investors (e.g. hedge fund, pensions, proprietary trading desks, etc.) as well.

Finally, the concept of a Borrowed Security may be implemented in conjunction with a system and method for various entities to allow, track, and/or monitor the Borrowed Security. In this regard, the system and method to allow, track, and/or monitor the Borrowed Security may be implemented as software, may be implemented in a computer, may be implemented across a communication system, may be implemented as a web-based system, and the like.

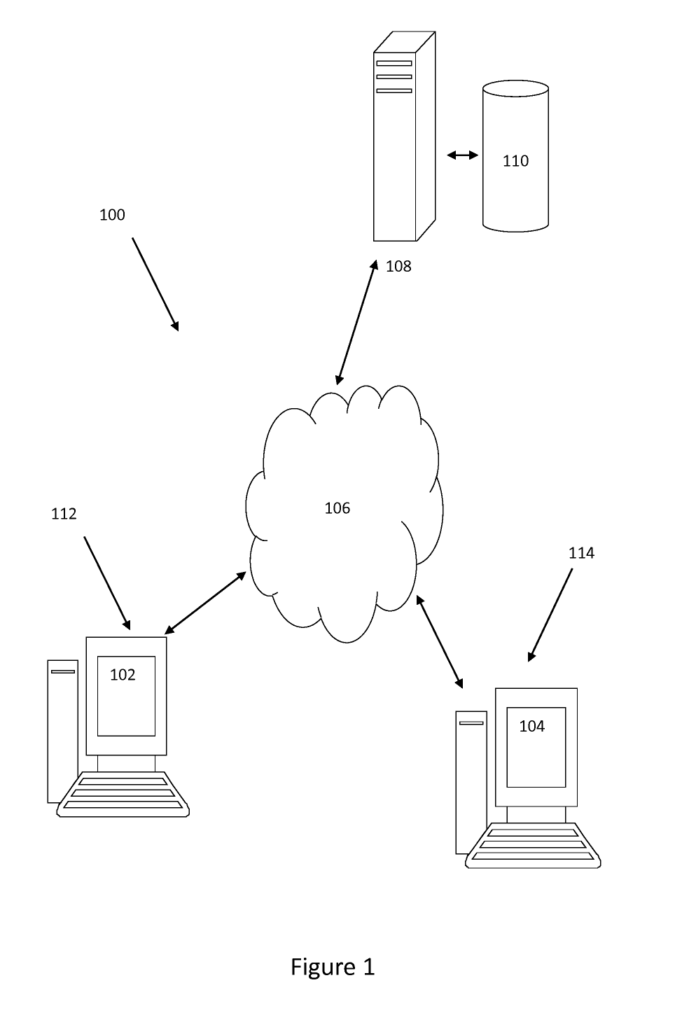

FIG. 1 shows exemplary architecture of a system constructed according to aspects of the invention. In a particular exemplary implementation, a borrowed security system 100 may implement the above described method. The borrowed security system 100 may include a communication network 106, a borrowed security transaction system 108, a database 110, a device 102 associated with an investor 112, a device 104 associated with a borrowed security lender 114, and the like.

The communication network 106 may couple the transaction system 108, the database 110, the device 102 associated with the investor 112, the device 104 associated with the borrowed security lender 114, and the like. The communication network 106 may be a wireless network, a wired network or any combination of wireless network and wired network. For example, the communication network 106 may include one or more of a fiber optic network, a passive optical network, a cable network, an Internet network, a satellite network (e.g., operating in Band C, Band Ku or Band Ka), a wireless LAN, a Global System for Mobile Communication (GSM), a Personal Communication Service (PCS), a long term evolution (LTE) network, a CDMA (Code-Division Multiple Access) network, W-CDMA (Wideband Code-Division Multiple Access) network, a Personal Area Network (PAN), D-AMPS, Wi-Fi, Fixed Wireless Data, IEEE 802.11a, 802.11b, 802.15.1, 802.11n and 802.11g network or any other wired or wireless network for transmitting and receiving a data signal. In addition, the communication network 106 may include, without limitation, telephone lines, fiber optics, IEEE Ethernet 802.3 channels, wide area network (WAN) channels, local area network (LAN), or global network aspects such as the Internet. The communication network 106 may support an Internet network, a wireless communication network, a cellular network, or the like, or any combination thereof.

The communication network 106 may further include one, or any number of the exemplary types of networks mentioned above operating as a stand-alone network or in cooperation with each other. Although the communication network 106 is depicted as one network, it should be appreciated that according to one or more embodiments, the communication network 106 may include a plurality of interconnected networks, such as, for example, a service provider network, the Internet, a broadcaster's network, a cable television network, corporate networks, home networks and the like.

The transaction system 108 may include one or more servers. For example, the transaction system 108 may include a UNIX based server, Windows 2000 Server, Microsoft IIS server, Apache HTTP server, API server, Java server, Java Servlet API server, ASP server, PHP server, HTTP server, Mac OS X server, Oracle server, IP server, other independent server or the like to support operations of a client. Also, the transaction system 108 may include one or more of an Internet Protocol (IP) network server or public switch telephone network (PSTN) server. The transaction system 108 may include one or more databases 110 for storing a network model topology, network policies based at least in part on the network model topology, and/or the like.

The device 102 associated with the investor 112 allows the investor 112 to interact with the communication network 106, the transaction system 108, and/or the database 110 in order to complete, at least in part, the process described herein. The device 102 may include, for example, a mobile phone, a smart phone, a computer, a personal computer, a laptop, a cellular communication device, a workstation, a mobile device, a phone, a television, a handheld PC, a personal digital assistant (PDA), a network appliance, an Internet accessible device, netbook, tablet computer, or any other device that may be in communication over the communication network 106.

The database 110 may include one or more memory storage devices including, without limitation, paper card storage, punched card, tape storage, paper tape, magnetic tape, disk storage, gramophone record, floppy disk, hard disk, ZIP disk, holographic, molecular memory or the like. The one or more storage devices may also include, without limitation, optical disc, CD-ROM, CD-R, CD-RW, DVD, DVD-R, DVD-RW, DVD+R, DVD+RW, DVD-RAM, Blu-ray, Minidisc, HVD, Phase-change Dual storage device and the like. The one or more storage devices may further include, without limitation, magnetic bubble memory, magnetic drum, core memory, core rope memory, thin film memory, twistor memory, flash memory, memory card, semiconductor memory, solid state semiconductor memory or any other like mobile storage devices.

The device 104 associated with the lender 114 allows the lender 114 to interact with the communication network 106, the transaction system 108, and/or the database 110 in order to complete, at least in part, the process described herein. The device 104 may include, for example, a mobile phone, a smart phone, a computer, a personal computer, a laptop, a cellular communication device, a workstation, a mobile device, a phone, a television, a handheld PC, a personal digital assistant (PDA), a network appliance, an Internet accessible device, netbook, tablet computer, or any other device that may be in communication over the communication network 106.

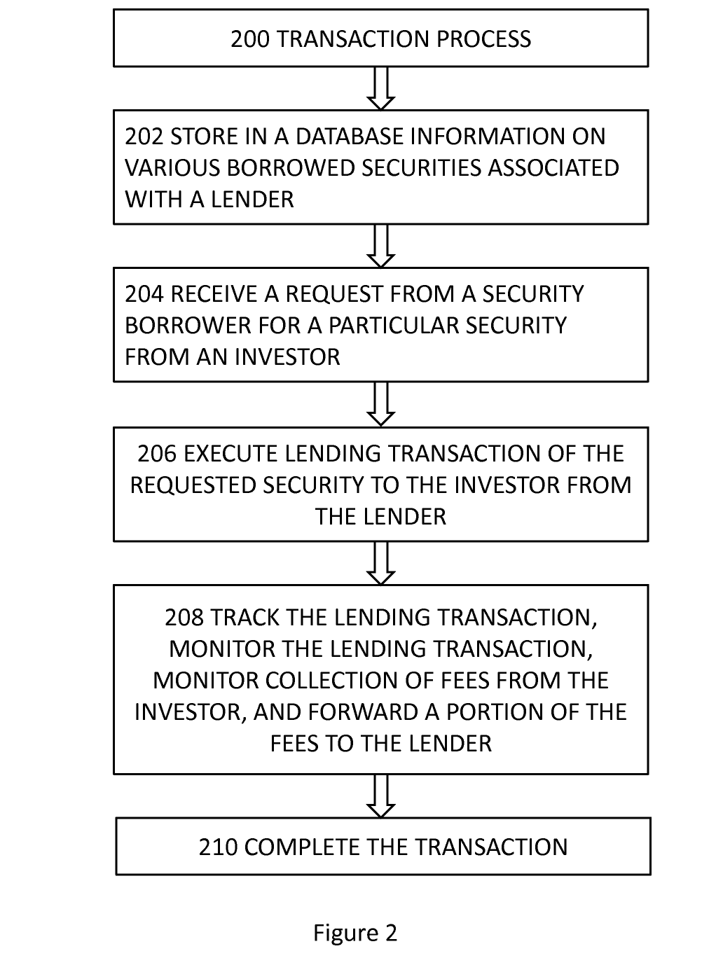

FIG. 2 shows a transaction process according to aspects of the invention. In particular, a transaction process 200 may include one or more of the following process steps. In step 202, the transaction system 108 may store in the database 110 various information on borrowed securities associated with the lender 114. The transaction system 108 and/or the database 110 may further include additional process steps to store information regarding the lender 114, communicate with the lender 114, provide reports to the lender 114, and the like.

In step 204, the transaction system 108 may receive a request from the investor 112 for a particular security from the lender 114. The transaction system 108 and/or the database 110 may further include additional process steps to store information regarding the investor 112, communicate with the investor 112, provide reports to investor 112, and the like.

Next, in step 206 the transaction system 108 may execute the process of lending the requested security to the investor 112 from the lender 114. The transaction system 108 and/or the database 110 may further include additional process steps to store information regarding the lending transaction, communicate with the investor 112 and the lender 114 regarding the lending transaction, provide reports to investor 112 and the lender 114 regarding the lending transaction, and the like.

In process step 208, the transaction system 108 may track the lending transaction to ensure that the lending transaction is fully completed and meets all of the desired transaction criteria. Thereafter, the transaction system 108 may monitor the lending transaction by monitoring desired criteria with respect to the investor 112 and the lender 114. Additionally, the transaction system 108 may ensure the collection of fees from the investor 112. This aspect of process step 208 may take place at any point in time during the transaction process 200. At any point during the transaction process 200, the transaction system 108 may forward a portion of the fees to the lender 114. Forwarding a portion of the fees to the lender 114 may take place after collection of fees from the investor 112, after the transaction is complete in step 210, or the like.

Accordingly, as described above, the invention provides a system and process to provide a security that closely mirrors returns of an individual security while also providing stock loan income. Moreover the invention provides a system and method to allow, track, and/or monitor the security that closely mirrors returns of an individual security while also providing stock loan income.

It should also be noted that the software implementations of the invention as described herein are optionally stored on a tangible non-transitory storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

The invention may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), the Global System for Mobile Communications (GSM) system, CDMA (Code-Division Multiple Access) system, W-CDMA (Wideband Code-Division Multiple Access) system, and/or the like, and/or a combination of two or more thereof.

The invention may be implemented in any type of computing devices, such as, e.g., a desktop computer, personal computer, a laptop/mobile computer, a personal data assistant (PDA), a mobile phone, a tablet computer, a cloud computing device, and the like, with wired/wireless communications capabilities via the communication channels.

In an embodiment, the invention may be web-based. For example, a server may operate a web application to allow the invention to operate in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™, Firefox™, Chrome™ Safari™ or the like) may render the application executable. A web-based service may be more beneficial due to the ubiquity of web browsers and the convenience of using a web browser as a client (i.e., thin client). Further, with inherent support for cross-platform compatibility, the web application may be maintained and updated without distributing and installing software on each.

In an embodiment, the invention may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft˜ Windows Mobile™ operating system, a Microsoft™ Windows Phone™ operating system, a Linux™ operating system or the like.

Further in accordance with various embodiments of the invention, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A transaction system that allows, tracks, and monitors at least one of an individual security and a security that closely mirrors returns of the individual security comprising:
a database that stores information related to at least one of the individual security and the security that closely mirrors returns of the individual security associated with a lender;
a server configured to receive a request from an investor to borrow at least one of the individual security and the security that closely mirrors returns of the individual security;
the server further configured to execute a lending transaction requested by the investor to borrow at least one of the individual security and the security that closely mirrors returns of the individual security;
the server further configured to track the lending transaction; and
the server further configured to monitor the lending transaction.

2. The transaction system according to claim 1 wherein the server is further configured monitor collection of fees from the investor associated with borrowing at least one of the individual security and the security that closely mirrors returns of the individual security.

3. The transaction system according to claim 2 wherein the server is further configured monitor forwarding a portion of the fees to the lender associated with borrowing at least one of the individual security and the security that closely mirrors returns of the individual security.

4. The transaction system according to claim 1 wherein the server is configured to communicate over a network.

5. The transaction system according to claim 1 wherein the server is configured to communicate over a network to a device associated with the lender.

6. The transaction system according to claim 1 wherein the server is configured to communicate over a network to a device associated with the lender.

7. A non-transitory computer readable medium that when executed on a computer allows, tracks, and monitors at least one of an individual security and a security that closely mirrors returns of the individual security comprising:
instructions for storing information related to at least one of the individual security and the security that closely mirrors returns of the individual security associated with a lender in a database;
instructions for receiving a request from an investor to borrow at least one of the individual security and the security that closely mirrors returns of the individual security in a server;
instructions for executing a lending transaction requested by the investor to borrow at least one of the individual security and the security that closely mirrors returns of the individual security with the server;
instructions for tracking the lending transaction with the server; and
instructions for monitoring the lending transaction with the server.

8. The non-transitory computer readable medium according to claim 7 further comprising instructions for monitoring collection of fees from the investor associated with borrowing at least one of the individual security and the security that closely mirrors returns of the individual security.

9. The non-transitory computer readable medium according to claim 8 further comprising instructions for monitoring forwarding of a portion of the fees to the lender associated with borrowing at least one of the individual security and the security that closely mirrors returns of the individual security.

10. The non-transitory computer readable medium according to claim 7 further comprising instructions for communicating over a network.

11. The non-transitory computer readable medium according to claim 7 further comprising instructions for communicating over a network to a device associated with the lender.

12. The non-transitory computer readable medium according to claim 7 further comprising instructions for communicating over a network to a device associated with the lender.

13. A process that allows, tracks, and monitors at least one of an individual security and a security that closely mirrors returns of the individual security using a database in a server comprising:
storing information related to at least one of the individual security and the security that closely mirrors returns of the individual security associated with a lender in a database;
receiving a request from an investor to borrow at least one of the individual security and the security that closely mirrors returns of the individual security in the server;
executing a lending transaction requested by the investor to borrow at least one of the individual security and the security that closely mirrors returns of the individual security with the server;
tracking the lending transaction with the server; and
monitoring the lending transaction with the server.

14. The process according to claim 13 further comprising monitoring collection of fees from the investor associated with borrowing at least one of the individual security and the security that closely mirrors returns of the individual security.

15. The process according to claim 14 further comprising monitoring forwarding of a portion of the fees to the lender associated with borrowing at least one of the individual security and the security that closely mirrors returns of the individual security.

16. The process according to claim 13 further comprising communicating over a network.

17. The process according to claim 13 further comprising communicating over a network to a device associated with the lender.

18. The process according to claim 13 further comprising communicating over a network to a device associated with the lender.
